(19) United States
(12) Patent Application Publication
(10) Pub. No.: US 2003/0224822 A1
(43) Pub. Date: Dec. 4, 2003

(54) Apparatus for transmitting data in a wireless communication system

(75) Inventors: Cheol Hee Park, Seoul (KR); Min-Chul Ju, Gyeonggi-do (KR); Dae-Ki Hong, Seoul (KR); Sung-Jin Kang, Daejeon (KR); Jin-Woong Cho, Gyeonggi-do (KR)

Correspondence Address: GREENBLUM & BERNSTEIN, P.L.C., 1950 ROLAND CLARKE PLACE, RESTON, VA, 20191, US

(73) Assignee: Korea Electronics Technology Institute, Gyeonggi-do (KR)

(21) Appl. No.: 10/391,023

(22) Filed: Mar. 19, 2003

(30) Foreign Application Priority Data
May 16, 2002 (KR) 10-2002-0027140

(51) Int. Cl. H04B 1/38

(52) U.S. Cl. 455/557; 455/60

(57) ABSTRACT

An apparatus for transmitting data in a wireless communication system is disclosed. An apparatus for transmitting data in a wireless communication system according to the present invention includes a serial to parallel converter operable to transform serial data into parallel data; a summer operable to combine the parallel data after multiplying them by orthogonal code; a level clipper operable to remove a portion of the summed signal above and below a desired threshold range; and a quadrature phase shift keying(QPSK) modulator operable to change the phase of the clipped signal and to transfer the modulated signal therefrom.

Thus, the present invention can embody high-speed data transfer rate in such a simple structure by combining a VSG method with an MC method to clip multi-level signals from the MC method and to maintain orthogonality of MC required in the VSG method.

### BACKGROUND OF THE INVENTION

1. Field of the Invention

The present invention relates in general to data transmitting techniques in a wireless communication system and more particularly to an apparatus for transmitting data in a wireless communication system, for example, a WPAN(Wireless Personal Area Network) and a cellular communication system, which makes it possible to transfer data fast and efficiently.

2. Background of the Related Art

The use of code division multiple access(CDMA) signals is a convenient technique of transmitting wireless signals. Many wireless systems process CDMA signals for the transmission of information. However, in accordance with the growth of the number of subscribers for WPAN and cellular systems and advancement of related technologies a need has arisen for transmitting more various data rapidly.

There are mainly two methods, which can be used to support high-speed transmission. These are Variable Spreading Gain(VSG) and Multi-Code(MC) methods. The method of VSG enhances transmission rate through reducing SG(Spreading Gain), while the method of MC heightens transmission rate through using multiple parallel branches. Both of them are largely used in CDMA systems, and are inapplicable except CDMA Systems.

However, these conventional high-speed transmission methods have several problems. For one thing, degradation of ability for detecting signals can be caused by using the VSG method to reduce SG for high-speed data transmission, and therefore, reliability of data transmission can be reduced. In other words, the limit of SG can generate the threshold of transmission rate.

On the other hand, in the method of MC, SG can be kept up constantly but there is a problem that transmission power increases since a summed signal has a multi-level characteristic at the sending end because signals from a plurality of branches are combined to create the summed signal before transmitting. Accordingly, the overall structure of a system can become complicated.

### SUMMARY OF THE INVENTION

Accordingly, the present invention is directed to an apparatus for transmitting data that substantially obviates one or more problems due to limitations and disadvantages of the related art.

An object of the present invention is to provide an apparatus for transmitting data in a wireless communication system, which combines a VSG method with an MC method to clip multi-level signals from the MC method and maintains the orthogonality of MC required in the VSG method, thereby embodying high-speed data transmission rate in such a simple structure.

To achieve this object and in accordance with the purpose of the invention, as embodied and broadly described herein, there is provided an apparatus for transmitting data in wireless communication systems, comprising:

a serial to parallel converter operable to transform serial data into parallel data;

a summer operable to combine the parallel data after multiplying them by orthogonal code, the summer being operable to generate a summed signal therefrom;

a level clipper operable to remove a portion of the summed signal above and below a desired threshold range, the level clipper being operable to generate a clipped signal therefrom; and

a quadrature phase shift keying(QPSK) modulator operable to convert the clipped signal into a phase-modulated signal through a QPSK modulation procedure, the QPSK modulator being operable to transfer the phase-modulated signal therefrom.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 is a schematic diagram of a sending end of an apparatus for transmitting data in a wireless communication system, according to a preferred embodiment of the invention;

FIG. 2 is an example of design of VSG method supporting transmission rate of 4.08 Mbps;

FIG. 3 illustrates a clipping operation performed by a level clipper and QPSK modulation rules implemented by a QPSK modulator, when λ₁=2 and λ₂=7;

FIG. 4 is a schematic diagram of a receiving end of an apparatus for transmitting data in a wireless communication system, according to a preferred embodiment of the invention; and

FIG. 5 is a graph comparing BER(Bit Error Rate) function of the data transmission apparatus according to an embodiment of the present invention with that of a Direct-Sequence Code Division Multiple Access(DS/CDMA) system.

### DETAILED DESCRIPTION OF THE PREFERRED EMBODIMENT

Reference will now be made in detail to the preferred embodiments of the present invention, examples of which are illustrated in the accompanying drawings.

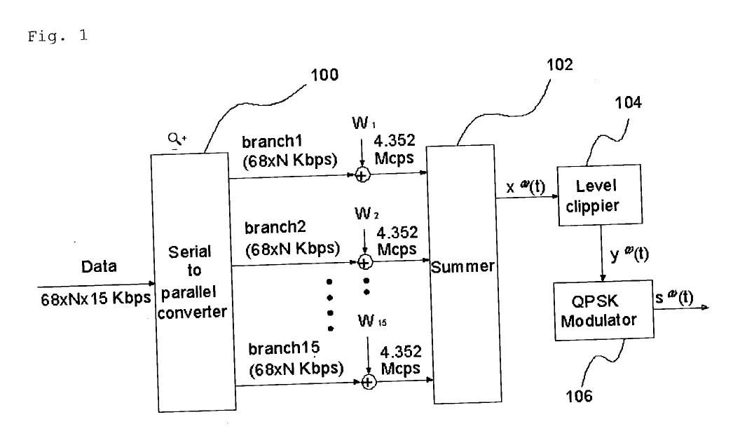

FIG. 1 is a schematic diagram of a sending end of an apparatus for transmitting data in a wireless communication system, according to a preferred embodiment of the invention. The sending end of the data transmission apparatus includes a serial to parallel converter 100, a summer 102, a level clipper 104, and a QPSK modulator 106. The serial to parallel converter transforms serial data that will be transmitted to parallel data. Then, the resulted parallel branches are multiplied by orthogonal codes (Wk, k=1,2,3, . . . , and 15) and are combined by a summer. The summer generates a summed code signal, which is transferred to a level clipper. The level clipper generates a clipped code signal in response to the summed code signal. The level clipper removes a portion of the summed code signal to improve handling of more frequently occurring values within a desired threshold range. In an embodiment of the present invention all the levels except four levels are clipped. The signal with four levels is transmitted via a QPSK modulation process.

In an embodiment of the present invention there are three transfer classes, where transfer class 1, transfer class 2, and transfer class 3 have the maximum data rate of 1.02 Mbps (N=1), 2.04 Mbps (N=2) and 4.08 Mbps (N=4), respectively. In order to satisfy these data rates each of multi-code branches is designed to have VSG of 16 chips, 32 chips, and 64 chips.

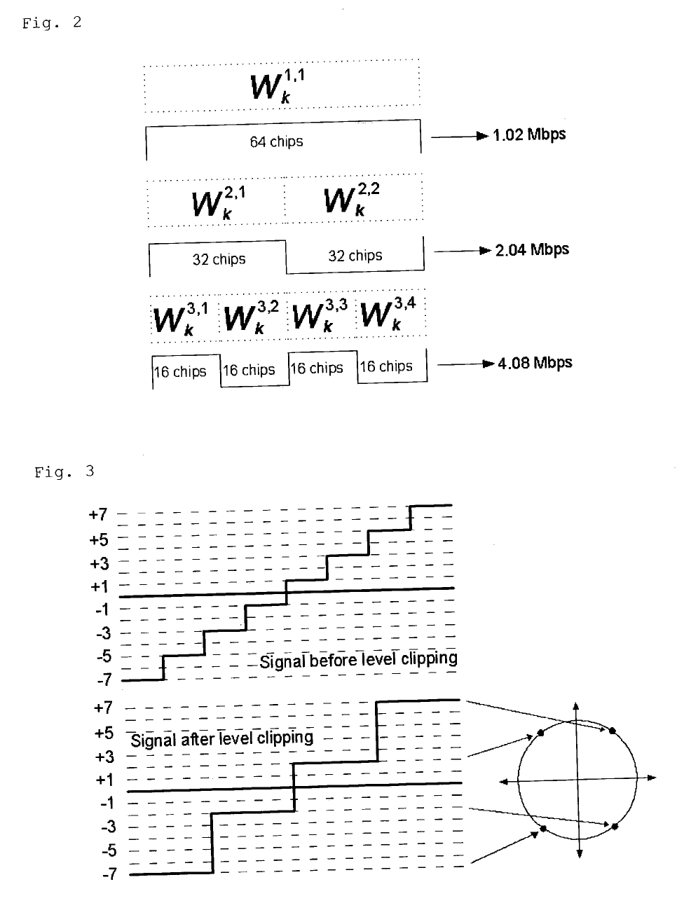

FIG. 2 is an example of design of VSG transmission method supporting transmission rate of 4.08 Mbps. As shown in this example, in each of the classes k-th multi-code can be expressed by the following equation:

$${W}_{k} = [ {W}_{k}^{1 , 1} ] = [ {W}_{k}^{2 , 1} {W}_{k}^{2 , 2} ] = [ {W}_{k}^{3 , 1} {W}_{k}^{3 , 2} {W}_{k}^{3 , 3} {W}_{k}^{3 , 4} ] \qquad ( 1 )$$

where multi-code Wₖ^{1,1} consists of 64 chips, Wₖ^{2,1} and Wₖ^{2,2} respectively consist of 32 chips, and Wₖ^{3,1}, Wₖ^{3,2}, Wₖ^{3,3}, and Wₖ^{3,4} respectively consist of 16 chips.

On the other hand, in order to apply a VSG method to a system with fifteen multi-code branches, it is necessary to select an adequate spreading code, and therefore, these fifteen branches should satisfy the following conditions in the transfer class i (i=1,2, and 3)

(Condition 1): If the spreading code is any M-ary Walsh code, among the code indexes satisfying the following equation only one code index should be used:

p mod (M/2ⁱ⁻¹)=q mod (M/2ⁱ⁻¹) (2)

where M=64, p and q are one of 64 Walsh code indexes(i.e., p, qε{1,2,3, . . . , 64}), mod is a modular operator, and the p and q are different code indexes.

(Condition 2): In order to achieve the transmission rate of 2ⁱ⁻¹ times, all of 2ⁱ⁻¹ sub-codes should maintain the orthogonality according to the following equation:

$${W}_{k}^{i , j} {W}_{l}^{i , {j}^{ T}} = \{ \begin{matrix}M / {2}^{i - 1} , & if & k = l \\ 0 , & if & k \neq l\end{matrix} \qquad ( 3 )$$

where j is a sub-code index and it ranges 1≦j≦2¹⁻¹.

In the M-ary Walsh code the number of codes which satisfy the conditions 1 and 2 can be calculated by the following equation (4):

$${N}_{p} = {\prod }_{k = 0}^{14} ( \begin{matrix}M ( 1 - k \cdot {2}^{- 4} ) \\ 1\end{matrix} ) / 15 ! \qquad ( 4 )$$

Here, all possible combinations of Nₚ codes are traced by code selection algorithm. In case of the system consisting of fifteen multi-code branches, a sum of 2¹⁵ data patterns are entered to all the branches. Accordingly, decision variables from a receiving end are generated by combinations of data and code branches a total of which is 15×2¹⁵, and the code selection algorithm assesses statistical characteristics of the decision variables. If, among the 2¹⁵ input patterns, k-th data pattern can be defined by the following equation (5), a decision variable from a receiving end can be defined by the following equation (6):

$$\begin{matrix}{D}^{( i )} ( k ) = [ {D}_{1}^{( i )} ( k ) , {D}_{2}^{( i )} ( k ) , … , {D}_{m}^{( i )} ( k ) , … , {D}_{{N}_{c}}^{( i )} ( k ) ] & ( 5 ) \\ {Z}^{( i )} ( k ) = [ {Z}_{1}^{( i )} ( k ) , {Z}_{2}^{( i )} ( k ) , … , {Z}_{m}^{( i )} ( k ) , … , {Z}_{{N}_{c}}^{( i )} ( k ) ] & ( 6 )\end{matrix}$$

Also, an inverse of the decision variable can be defined by the following equation (7):

$$\overline{{Z}^{( i )}} ( k ) = [ \overline{{Z}_{1}^{( i )}} ( k ) , \overline{{Z}_{2}^{( i )}} ( k ) , … , \overline{{Z}_{m}^{( i )}} ( k ) , … , \overline{{Z}_{{N}_{c}}^{( i )}} ( k ) ] \qquad ( 7 )$$

With the decision variable above, two code selection algorithms can be constructed. The code selection algorithms decide the code to minimize the two variables defined by the following equations:

$$\begin{matrix}η = {E}_{k} \{ {}_{m}^{max} \vert \overline{{Z}_{m}^{( i )}} ( k ) \vert \} \\ η = {E}_{k} \{ \sqrt{{\sum }_{m = 1}^{{N}_{c}} {\vert \overline{{Z}_{m}^{( i )}} ( k ) \vert}^{2}} \}\end{matrix} \qquad ( 8 )$$

where Eₖ{•} is an expectation operator for an input data pattern index, k.

On the other hand, x⁽ⁱ⁾(t) is the sum to totalize class i in each of multi-code branches and means a multi-level signal which has one value among ±1, ±2, ±3, . . . , ±15. A level clipper 104 trims multi-level signals from each of chips according to the following equation (9), and the clipped signal y⁽ⁱ⁾(t) can be expressed by the following equation:

$$\begin{matrix}{y}^{( i )} ( t ) = \{ \begin{matrix}+ {λ}_{2} , & if & {x}^{( i )} ( t ) > \frac{{λ}_{1} + {λ}_{2}}{2} \\ + {λ}_{1} , & if & 0 \leq {x}^{( i )} ( t ) \leq \frac{{λ}_{1} + {λ}_{2}}{2} \\ - {λ}_{1} , & if & - \frac{{λ}_{1} + {λ}_{2}}{2} \leq {x}^{( i )} ( t ) < 0 \\ - {λ}_{2} , & if & {x}^{( i )} ( t ) < - \frac{{λ}_{1} + {λ}_{2}}{2}\end{matrix} \\ where {λ}_{1} = 2 and {λ}_{2} = 7 .\end{matrix} \qquad ( 9 )$$

FIG. 3 illustrates a clipping operation performed by a level clipper and QPSK modulation rules implemented by a QPSK modulator, when λ₁=2 and λ₂=7. As shown in Table 1 and FIG. 3, an apparatus for transmitting data in an embodiment of the invention delivers data through QPSK modulation.

TABLE 1

| | | | | |
|---|---|---|---|---|
| Clipping level | λ₁ | −λ₁ | λ₂ | −λ₂ |
| Phase | 3π/4 | −π/4 | π/4 | −π/4 |

Here, QPSK modulation rules are designed to maximize the distance between λ₁ and −λ₁, and between λ₂ and −λ₂. As a result a QPSK signal, s⁽ⁱ⁾(t), which is transmitted via a QPSK modulator at a sending end can be expressed by the following equation (10):

$${s}^{( i )} ( t ) = \sqrt{{N}_{c} {P}_{c}} {h}_{a} ( t ) \{ \begin{matrix}exp \{ j \frac{π}{4} \frac{{y}^{( i )} ( t )}{\vert {y}^{( i )} ( t ) \vert} \} & if & {y}^{( i )} ( t ) ∈ \{ - {λ}_{1} , {λ}_{2} \} \\ exp \{ j \frac{3 π}{4} \frac{{y}^{( i )} ( t )}{\vert {y}^{( i )} ( t ) \vert} \} & if & {y}^{( i )} ( t ) ∈ \{ {λ}_{1} , - {λ}_{2} \}\end{matrix} \qquad ( 10 )$$

where P_{c}, is energy of transmission chip, and hₐ(t) is a filter for shaping a magnitude of signal.

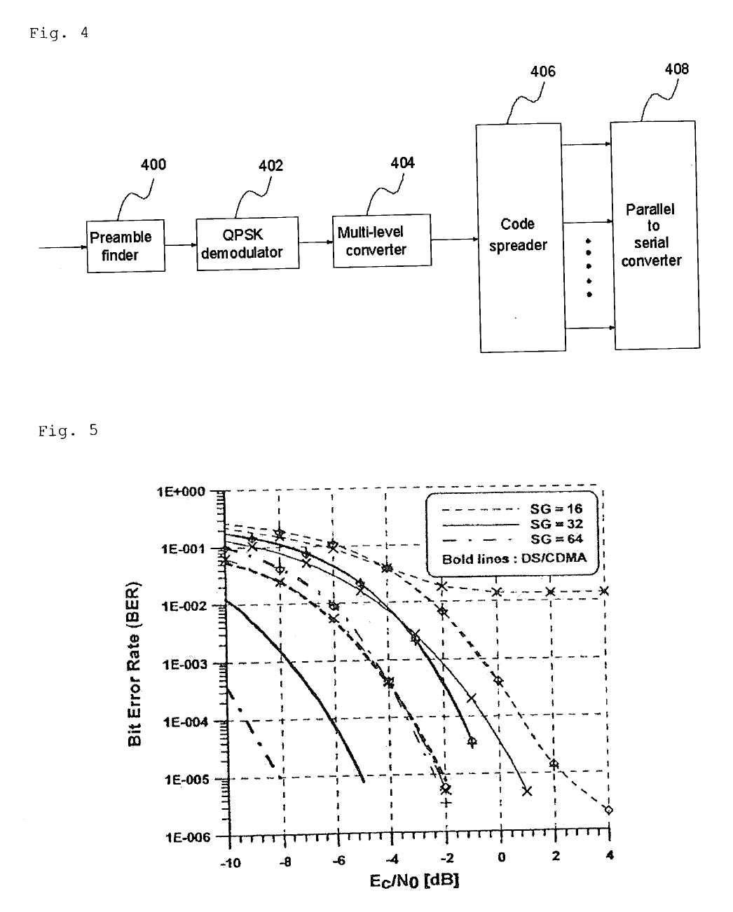

FIG. 4 is a schematic diagram of a receiving end of an apparatus for transmitting data in a wireless communication system, according to a preferred embodiment of the invention. As illustrated in FIG. 4, the receiving end includes a preamble finder 400, a QPSK demodulator 402, a multi-level converter 404, a code spreader 406, and a parallel to serial converter 408.

After a preamble finder 400 detects a start point of a packet, the transferred four-level signal is recovered by a QPSK demodulator 402. Here, the recovered signal is the four-level signal that was clipped at the sending end. The recovered four-level signal is multiplied by the multi-codes to correspond with each of branches and is restored to the signals that were transferred to branches from a serial to parallel converter at a sending end, through correlation process. Finally, the restored signals in branches return to the original signal through a parallel to serial process at a parallel to serial converter 408.

Table 2 shows packets used in an apparatus for transmitting data in accordance with an embodiment of the invention.

TABLE 2

| | Packet | User | Effective | Max. rate |
|---|---|---|---|---|
| Link type | name | payload | payload | (Mbps) |
| Data | DLU1 | 0-68 | 0-1020 | 0.408 |
| | DMU1 | 0-238 | 0-3570 | 0.714 |
| | DHU1 | 0-408 | 0-6120 | 0.816 |
| | DLU2 | 0-136 | 0-2040 | 0.816 |
| | DMU2 | 0-476 | 0-7140 | 1.428 |
| | DHU2 | 0-816 | 0-12240 | 1.632 |
| | DLU4 | 0-272 | 0-4080 | 1.632 |
| | DMU4 | 0-952 | 0-14280 | 2.856 |
| | DHU4 | 0-1632 | 0-24480 | 3.264 |
| Voice | UV1 | n/a | n/a | 68.0 |
| | UV2 | n/a | n/a | 68.0 |
| | UV3 | n/a | n/a | 68.0 |

As shown in Table 2, twelve packets are defined as a type of voice or data, and generally they fall into one class among three classes such as DLU(Data-Law Uncoded) packet, DMU(Data-Medium Uncoded) packet, and DHU(Data-High Uncoded) packet. DLU packet occupies one time slot. DMU packet occupies three time slots. And DHU packet occupies five time slots. In addition, DXX1 packet, DXX2 packet, and DXX4 packet are those which SG is 64, 32 and 16, respectively. On the other hand, HV(High-quality Voice) packet supports the transmission rate of 68 Kbps.

FIG. 5 is a graph comparing BER(Bit Error Rate) performance of the data transmission apparatus according to an embodiment of the present invention with that of a Direct-Sequence Code Division Multiple Access(DS/CDMA) system, when SG is 16, 32, and 64, respectively. As shown in FIG. 5, compared with the existing DS/CDMA system, the BER performance of an embodiment of the invention decreases to 4 dB, 4.5 dB, and 6 dB when SG is 16, 32, and 64, respectively because signals are clipped. However, data rate in a data transmission apparatus according to an embodiment of the invention is 1.02 Mbps, 2.04 Mbps, and 4.08 Mbps, respectively, while data rate in the DS/CDMA system is 68 Kbps, 136 Kbps, and 272 Kbps, respectively.

Thus, there has been provided in accordance with the present invention, an apparatus for transmitting data in a wireless communication system that can simplify a system structure and embody high-speed transmission rate by clipping a multi-level signal generated from data transfer equipment using MC method.

The foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. An apparatus for transmitting data in a wireless communication system, comprising:
a serial to parallel converter operable to transform serial data into parallel data;
a summer operable to multiply the parallel data by orthogonal codes and combine the parallel data, the summer being operable to generate a summed signal therefrom;
a level clipper operable to remove a portion of the summed signal above and below a desired threshold range, the level clipper being operable to generate a clipped signal therefrom; and
a quadrature phase shift keying(QPSK) modulator operable to change the phase of the clipped signal, the QPSK modulator being operable to transfer the modulated signal thereform.

2. The apparatus of claim 1, combining a VSG method with an MC method to clip multi-level signals from the MC method and to maintain orthogonality of MC required in the VSG method.

3. The apparatus of claim 1, wherein the level clipper generates a specific signal according to the following equation:
$${y}^{( i )} ( t ) = \{ \begin{matrix}+ {λ}_{2} , & if & {x}^{( i )} ( t ) > \frac{{λ}_{1} + {λ}_{2}}{2} \\ + {λ}_{1} , & if & 0 \leq {x}^{( i )} ( t ) \leq \frac{{λ}_{1} + {λ}_{2}}{2} \\ - {λ}_{1} , & if & - \frac{{λ}_{1} + {λ}_{2}}{2} \leq {x}^{( i )} ( t ) < 0 \\ - {λ}_{2} , & if & {x}^{( i )} ( t ) < - \frac{{λ}_{1} + {λ}_{2}}{2}\end{matrix}$$

4. The apparatus of claim 1, wherein the QPSK modulator generates a specific signal according to the following equation:
$${s}^{( i )} ( t ) = \sqrt{{N}_{c} {P}_{c}} {h}_{a} ( t ) \{ \begin{matrix}exp \{ j \frac{π}{4} \frac{{y}^{( i )} ( t )}{\vert {y}^{( i )} ( t ) \vert} \} & if & {y}^{( i )} ( t ) ∈ \{ - {λ}_{1} , {λ}_{2} \} \\ exp \{ j \frac{3 π}{4} \frac{{y}^{( i )} ( t )}{\vert {y}^{( i )} ( t ) \vert} \} & if & {y}^{( i )} ( t ) ∈ \{ {λ}_{1} , - {λ}_{2} \}\end{matrix}$$

5. The apparatus of claim 1, adopting code selection method according to the following equations:
$$\begin{matrix}η = {E}_{k} {\{}_{ m}^{max} \vert \overline{{Z}_{m}^{( i )}} ( k ) \vert \} \\ η = {E}_{k} \{ \sqrt{{\sum }_{m = 1}^{{N}_{c}} {\vert \overline{{Z}_{m}^{( i )}} ( k ) \vert}^{2}} \}\end{matrix}$$

6. The apparatus of claim 1, wherein the wireless communication system is a WPAN(Wireless Personal Area Network) system.
